(19) United States
(12) Patent Application Publication
(10) Pub. No.: US 2010/0031093 A1
(43) Pub. Date: Feb. 4, 2010

(54) Internal tracing method for network attack detection

(75) Inventors: Meng Sun, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/010,698

(22) Filed: Jan. 29, 2008

(51) Int. Cl. G06F 11/34; G06F 9/45; G06F 11/00

(52) U.S. Cl. 714/45; 726/25; 714/E11.199; 726/23

(57) ABSTRACT

An internal tracing method for network attack detection is used to trace whole life cycle of an attack data packet for test in different phases such as an attacking phase, a defending phase, and an attacked phase through configuring and uniting three parties including an attack end point (AEP), a detect end point (DEP), and a target end point (TEP) and setting a corresponding internal check point in each part when testing a network intrusion detection system (IDS). In other words, when testing the network IDS, in a whole period that the attack data packet for test is attacking, filtered, detected, and finally transmitted to a target host, a tester may clearly know the statuses and information of the data packet in each important phase, thereby generating a test report conveniently, quickly, and accurately.

### BACKGROUND OF THE INVENTION

1. Field of Invention

The present invention relates to a method of testing an intrusion detection system (IDS), and more particularly to an internal tracing method for network attack detection for testing a network IDS.

2. Related Art

At present, there are many kinds of testing tools for testing an intrusion detection system (IDS) in this industry. In a special networked attached storage (NAS) scheme, a tester adopts several types of tools and technologies to test Snort, which is a currently adopted small-scale network IDS and may analyze network communication and the log of IP packets in real time. Furthermore, Snort may perfectly finish the analysis of protocols, content searching/matching, and detect various attacks and scans, such as buffer overflow, port scan, attacks of a common gateway interface (CGI), and exploration of server message block (SMB). Snort uses a flexible rule language to describe information that should be collected or filtered, and functions like a detection engine to use a module plug-in system structure. The tools and technologies include, for example, Traffic IQ (It's an attack simulation software, containing abundant attack script libraries, covering worms, backdoor Trojan and spy software, Deny of Service (DoS) attack, and Distribution Denial of Service (DDoS) attack, and it further provides an interface to enable the users to define new attack files by themselves for the attack scripts against web pages, FTP (File Transfer Protocol), Emails, data bases, and other servers, and RPC (Remote Procedure Call) remote exploits, so it has with preferable expandability. Furthermore, it further provides almost all common protocols, so as to assist the investigation of protocol supporting ability of devices under test); IDS Informer (It's an advanced packet retransmission tool, including a unique and secure packet distribution mechanism without any protocol and service. It may allow users to transmit predefined attack data between two network cards, simulate the operation of a computer system at a hardware level, and simulate any one source IP address and destination IP address. Such simulated attack task may be performed on any running network without worrying about accompanying additional risks. The task is controlled by the IDS Informer, and may be repeated at any time, or occur according to predefined definition); Nmap (Network Mapper, which is an open-source network exploratory and security auditing tool. It is designed to quickly scan a large-scale network, and of course, it may be used to scan a single host without causing any errors. Nmap uses an original IP message in a novel manner to discover the hosts in the network and what kind of services they provide (application programs' names and versions), which operating systems the services are running in (including version information), and which kind of screening programs/firewalls and other functions they use. Although Nmap is usually used for security audition, many system administrators and network administrators also use it to do some daily work, for example, look over the information of the whole network, manage service update plans, and monitor the operation of the mainframe and service); Stick (A DoS tool for IDS, uses the rule of Snort as the input); Snot (A DoS tool for IDS, uses the rule of Snort as the input. Snot is an arbitrary packet generator and uses Snort rule files as its source of packet information. It could instantaneously generate arbitrary information that is not contained in the rule, to hamper the generation of ‘snot detection’ snort rules); Sneeze; and Hping (a command-line-based TCP/IP tool, applied in UNIX well, and always used as a security tool to test the security of network and hosts). However, testers have found the following problems as using these tools and technologies for test.

(1) Many test tools send a lot of attack data packets, but the number of alert events detected by Snort is often smaller than the number of packets sent by the attack tools. This phenomenon sometimes may be explained by the detection principle of Snort, but more circumstances cannot be explained clearly. Snort is a large system, filtering data packets with many layers, and there are various types of attack data packets, so testers cannot know whether these attack data packets are filtered normally or lost in some steps.

(2) Because the whole process of attacking, defending, and being attacked is performed in a manner of invisible black box operation, and especially under the circumstance that the environment, attack tool, and detect tool cannot be ensured to be totally reliable, it is quite difficult for testers to give an accurate and convincible determination for test results.

(3) In addition, when transferring Snort, it will find that Snort is a large system with a lot of working modules. Technical staff transferring Snort often wonders which modules may be uninstalled, which may have low detection efficiency, and which maybe the main parts in defense. Although the aforementioned problems may be partially solved by technical staff through analyzing source codes, it is preferable to have a detection tool or method to test each item of specific data.

### SUMMARY OF THE INVENTION

In order to solve the problems and defects in the conventional technology, the present invention is directed to provide an internal tracing method for network attack detection, which is used to trace whole life cycle of an attack data packet for test in different phases such as an attacking phase, a defending phase, and an attacked phase through configuring and integrating three parties including an attack end point (AEP), a detect end point (DEP), and a target end point (TEP) and setting a corresponding internal check point in each part.

The internal tracing method for network attack detection provided by the present invention includes the following steps.

Firstly, establish a network topology structure with an AEP, a DEP, and a TEP in a test network; install all types of attack tools and an AEP routine at the AEP, install a pre-customized Snort IDS and a DEP routine at the DEP, and install a statistics routine at the TEP; the AEP classifies the attack types of the attack data packets, and sets a check point for capturing information in the data packets according to the classification information; the DEP sets corresponding check points in different phases, stores all setting options to be a script file, and sends the script file to the other end points; the AEP sends an attack data packet for test to the DEP or the TEP through the distributed script file, and outputs the check point information to a draft to be stored; the DEP monitors the attack data packets sent from the AEP through a bypass interception mode, and outputs the check point information to a draft in a log mode to be stored; the TEP detects the received attack data packets, records the logs, and outputs the logs to a draft to be stored; and the DEP collects the drafts from the other end points at the end of the attack task, matches the flow information of each attack data packet in all the drafts, and then generates a final test report upon analysis.

Based on the above, an internal tracing method for network attack detection provided by the present invention is used to trace whole life cycle of an attack data packet for test in different phases such as an attacking phase, a defending phase, and an attacked phase through configuring and integrating three parties including an AEP, a DEP, and a TEP and setting a corresponding internal check point in each part. In other words, when a network IDS is under test, in a whole period that an attack data packet for test is attacking, filtered, detected, and finally transmitted to a target host, a tester may clearly know the statuses and information of the data packet in each important phase, thereby generating a test report conveniently, quickly, and accurately, solving the problems in the aforementioned conventional art, and efficiently assisting developers to understand the operation mechanisms of the whole defense system and IDS modules more directly.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the whole architecture of a system in which the internal tracing method for network attack detection provided by the present invention runs;

FIG. 2 is a schematic view of the system in FIG. 1 performing a distribution task;

FIG. 3 is a schematic view of the system in FIG. 1 performing an attack task and recording it;

FIG. 4 is a schematic view of the system in FIG. 1 performing a collect task and generating a report; and

FIG. 5 is a flow chart of the whole steps of the internal tracing method for network attack detection provided by the present invention.

### DETAILED DESCRIPTION OF THE INVENTION

The preferred embodiment of the present invention will be illustrated in detail with reference to drawings.

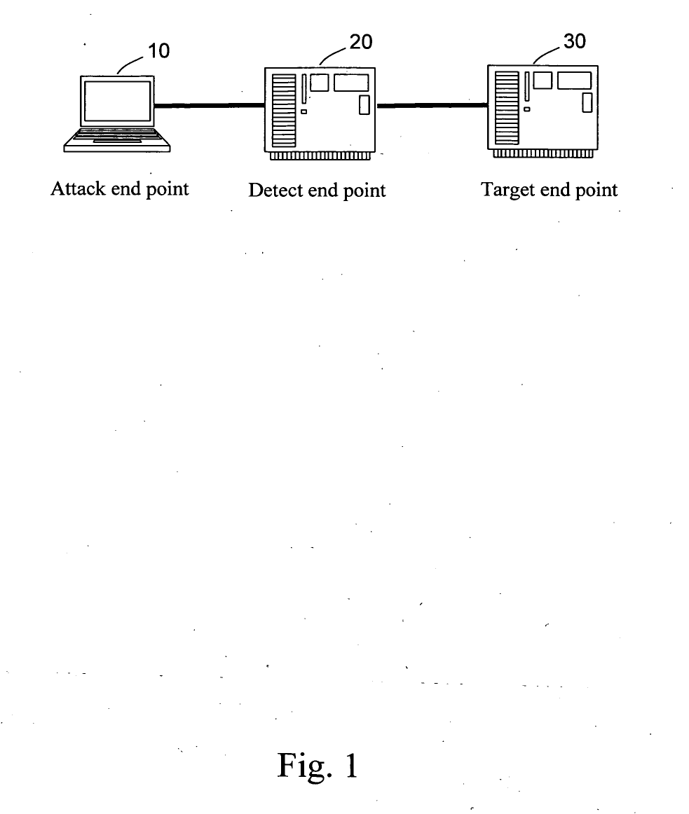

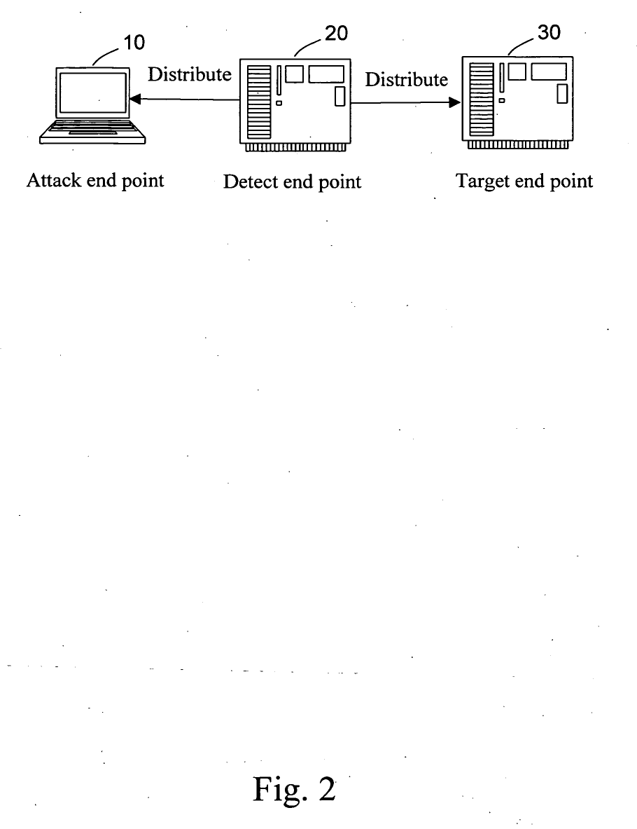

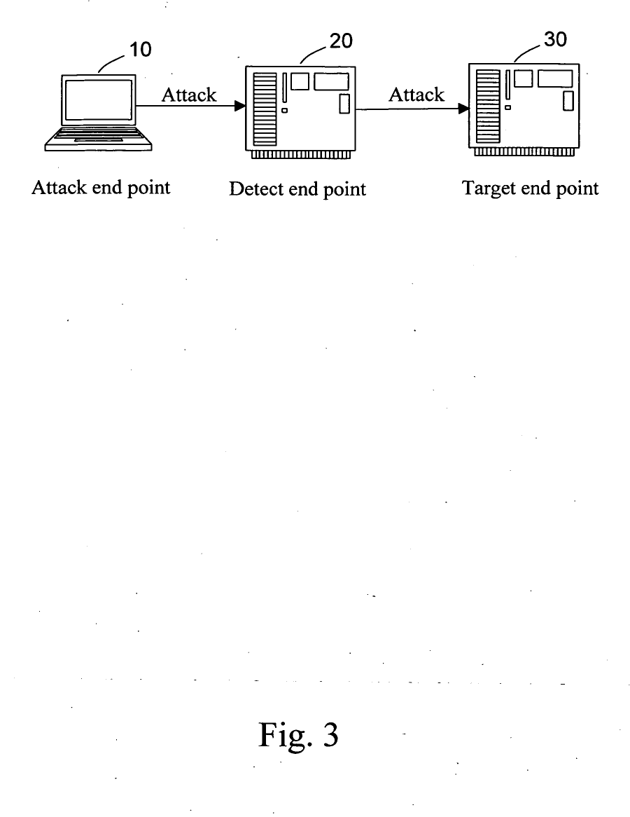

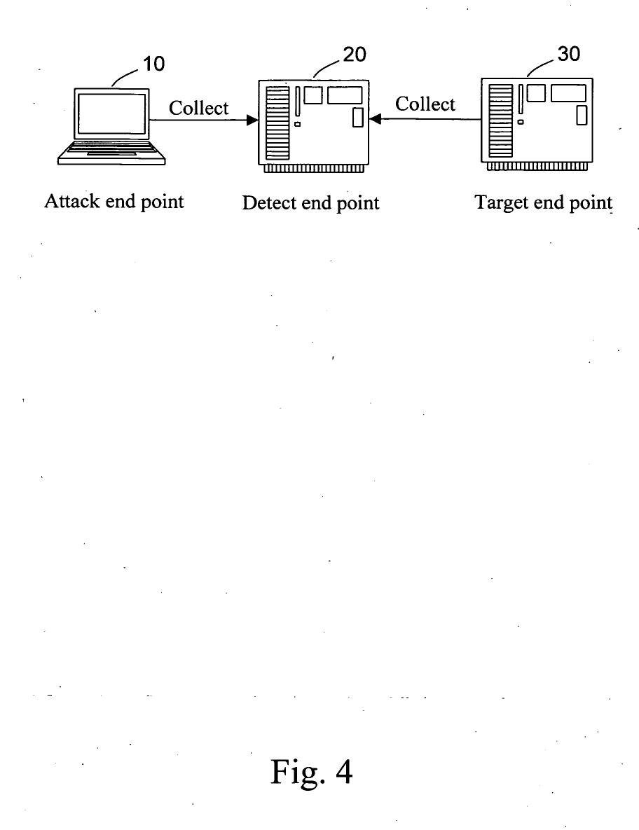

Referring to FIGS. 1-4, FIG. 1 is a schematic view of the whole architecture of a system in which the internal tracing method for network attack detection provided by the present invention runs; FIG. 2 is a schematic view of the system in FIG. 1 performing a distribution task; FIG. 3 is a schematic view of the system in FIG. 1 performing an attack task and recording it; and FIG. 4 is a schematic view of the system in FIG. 1 performing a collect task and generating a report. As shown in FIG. 1, the internal tracing method for network attack detection provided by the present invention includes the follows.

An attack end point (AEP) 10 is a computer host in a network, and is installed with all types of attack tools and AEP routines. The AEP 10 sends attack data packets for test to a target end point (TEP) 30 under attack, classifies the types of the attack data packets, and sets check points for capturing the information according to the classification information. The check points may be set through directly modifying the source codes of the attack tool, or analyzing the real-time log of the attack tool, and then the check points are output to a draft to be stored.

A detect end point (DEP) 20 is installed with a customized Snort intrusion detection system (IDS) and a DEP routine. The DEP 20 adds a new log mode for Snort, and meanwhile sets corresponding check points in different phases, thereby monitoring the status and information of the attack data packets in the whole transmission test process from the AEP 10 to the TEP 30 through a bypass interception mode, and outputting the status and information to a draft in the log mode to be stored.

THE target end point (TEP) 30 is installed with a statistics routine. The TEP 30 uses Libpcap (a well-known process property analysis software for constructing a network sniffer tool) to detect the received attack data packets with specified source IPs, record a log, and output the log to a draft to be stored.

As shown in FIG. 2, when the system in which the internal tracing method for network attack detection provided by the present invention runs is performing a distribution task, the DEP 20 stores all setting options to be a script file, and sends the script file to other end points.

As shown in FIG. 3, when the system in which the internal tracing method for network attack detection provided by the present invention runs is performing the attack task and making a record, the AEP 10 performs the attack task on the DEP 20 or the TEP 30 through the distributed script file. Then, the AEP 10, the DEP 20, and the TEP 30 write the check point information and the attack task to a draft to be stored.

As shown in FIG. 4, when the system in which the internal tracing method for network attack detection provided by the present invention runs is performing a collect task and generating a report, the DEP 20 collects the drafts from the other end points at the end of the attack task, matches the flow information of each attack data packet in all the drafts, and then generates a final test report upon analysis.

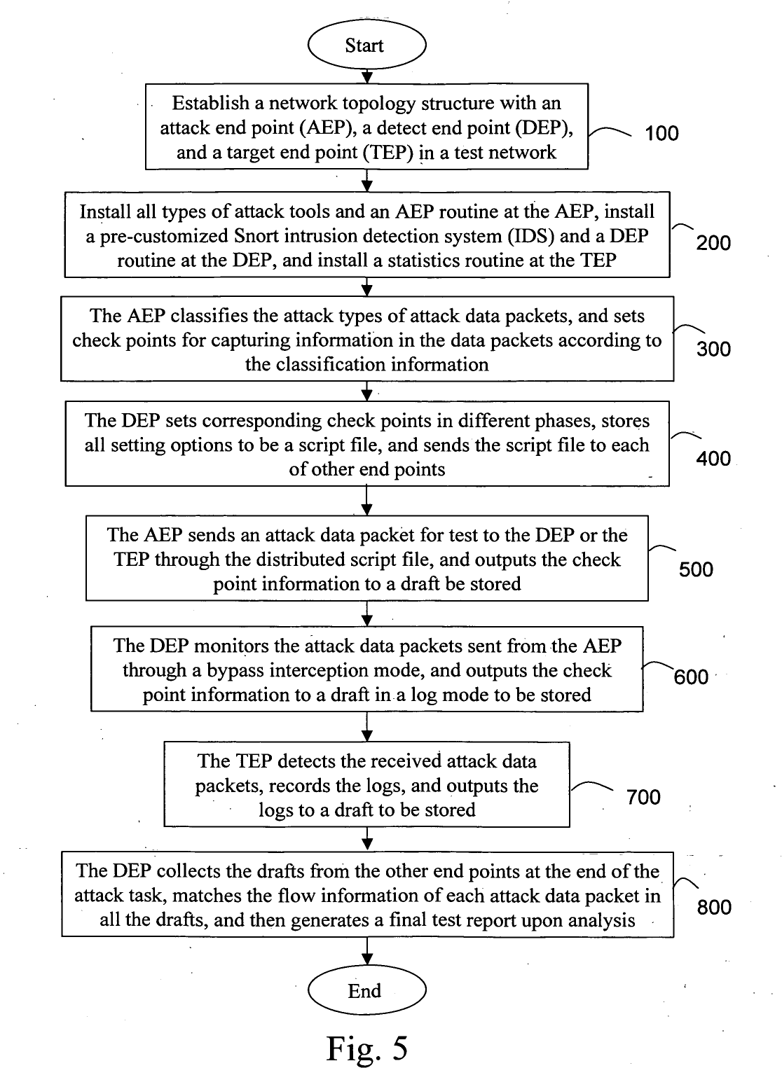

Referring to FIG. 5, a flow chart of the whole steps of the internal tracing method for network attack detection provided by the present invention is shown. As shown in FIG. 5, the internal tracing method for network attack detection provided by the present invention includes the following steps.

Firstly, establish a network topology structure having an AEP, a DEP, and a TEP in a test network (Step 100);

Install all types of attack tools and an AEP routine at the AEP, install a pre-customized Snort intrusion detection system and a DEP routine at the DEP, and install a statistics routine at the TEP (Step 200);

The AEP classifies the attack types of attack data packets, and sets check points for capturing information in the data packets according to the classification information (Step 300), in which the check points of the AEP are set through directly modifying the source codes of the attack tools, or analyzing the real-time log of the attack tools;

The DEP sets corresponding check points in different phases, stores all setting options to be a script file, and sends the script file to other end points (Step 400);

The AEP sends an attack data packet for test to the DEP or the TEP through the distributed script file, and outputs the check point information to a draft to be stored (Step 500);

The DEP monitors the attack data packets sent from the AEP through a bypass interception mode, and outputs the check point information to a draft in a log mode to be stored (Step 600);

The TEP detects the received attack data packets, records the logs, outputs the logs to a draft to be stored (Step 700); and

The DEP collects the drafts from the other end points at the end of the attack task, matches the flow information of each attack data packet in all the drafts, and then generates a final test report upon analysis (Step 800).

Furthermore, before the AEP sends the attack data packet for test, the internal tracing method for network attack detection provided by the present invention further comprises verifying system times of the end points to obtain system time differences of different end points, which are stored by any of the end points.

Furthermore, in the internal tracing method for network attack detection provided by the present invention, in the process of performing the attack task, each of the end points records the arriving time of the attack data packet, decodes the captured data packet with a protocol, a target port, and a protocol type, and matches it with the sent data packet, so as to determine whether the captured data packet is consistent with the sent data packet.

Furthermore, in the internal tracing method for network attack detection provided by the present invention, the process of the DEP detecting the attack data packets further includes the following steps.

The check point calculates the quantity of all captured attack data packets, and records the time stamps of the attack data packets.

After decoding, the check point filters the attack data packets through a specific IP or other flags in the attack data packets, marks the abnormal data packets as suspicious data packets, and records the protocol information and the time stamps.

After finding the suspicious data packets, if the suspicious data packets match with the rule of a preprocessor, the check point records the information of the preprocessor, and then records the current time stamps of the suspicious data packets.

After finding the suspicious data packets, the check point records a whole process matching with the rules in a rule tree node (RTN)/an optional tree node (OTN), and then records the current time stamps of the suspicious data packets.

At the end of processing the data packets, the check point records a selected event, and then records the current time stamps.

In addition, in the internal tracing method for network attack detection provided by the present invention, the TEP uses Libpcap (a well-known process property analysis software for constructing a network sniffer tool) to detect the received attack data packets, wherein the attack data packets are attack data packets with specified source IPs.

What is claimed is:

1. An internal tracing method for network attack detection, for testing a network intrusion detection system (IDS), comprising:
establishing a network topology structure having an attack end point (AEP), a detect end point (DEP), and a target end point (TEP) in a test network;
installing all types of attack tools and an AEP routine at the AEP, installing a pre-customized Snort IDS and a DEP routine at the DEP, and installing a statistics routine at the TEP;
the AEP classifying the attack types of attack data packets, and setting a check point for capturing information in the data packets according to the classification information;
the DEP setting corresponding check points in different phases, storing all setting options to be a script file, and sending the script file to the other end points;
the AEP sending the attack data packets for test to the DEP or the TEP through the distributed script file, and outputting the check point information to a draft to be stored;
the DEP monitoring the attack data packets sent from the AEP through a bypass interception mode, and outputting the check point information to a draft in a log mode to be stored;
the TEP detecting the received attack data packets, recording the logs, and outputting the logs to a draft to be stored; and
the DEP collecting the drafts from the other end points at the end of the attack task, matching the flow information of each attack data packet in all the drafts, and then generating a final test report upon analysis.

2. The internal tracing method for network attack detection as claimed in claim 1, wherein the check points of the AEP are set through directly modifying the source codes of the attack tool, or analyzing the real-time log of the attack tool.

3. The internal tracing method for network attack detection as claimed in claim 1, wherein before the AEP sends the attack data packets for test, the method further comprises verifying the system times of each of the end points to obtain system time differences of different end points, which are stored by any of the end points.

4. The internal tracing method for network attack detection as claimed in claim 1, wherein in the process of performing the attack task, each of the end points records the arriving time of the attack data packet, decodes a captured data packet and matches it with a recorded sent data packet, so as to determine whether the captured data packet is consistent with the sent data packet.

5. The internal tracing method for network attack detection as claimed in claim 1, wherein the process of the DEP detecting the attack data packet further comprises:
the check point calculating the quantity of all captured attack data packets, and recording the time stamps of the attack data packets;
after decoding, the check point filtering the attack data packets through a specific IP or other flags in the attack data packets, marking the abnormal data packets as suspicious data packets, and recording the protocol information and the current time stamps;
after finding the suspicious data packets, if the suspicious data packets match with a rule of a preprocessor, the check point recording the information about the preprocessor, and then recording the current time stamps of the suspicious data packets;
after finding the suspicious data packet, the check point recording a whole process for matching with the rules in a rule tree node (RTN)/an optional tree node (OTN), and then recording the current time stamp of the suspicious data packets; and
at the end of processing the data packets, the check point recording a selected event, and then recording the current time stamps.

6. The internal tracing method for network attack detection as claimed in claim 1, wherein the TEP uses Libpcap (a well-known process property analysis software for constructing a network sniffer tool) to detect the received attack data packets.

7. The internal tracing method for network attack detection as claimed in claim 6, wherein the attack data packets are attack data packets with specified source IPs.
